(19) United States
(12) Patent Application Publication
(10) Pub. No.: US 2016/0101543 A1
(43) Pub. Date: Apr. 14, 2016

(54) Hybrid Laminate and Molded Composite Structures

(71) Applicant: The Boeing Company, Chicago, IL (US)

(72) Inventors: Edward M. Fisher, JR., Huntsville, AL (US); Adriana W. Blom, Shoreline, WA (US)

(73) Assignee: The Boeing Company, Chicago, IL (US)

(21) Appl. No.: 14/095,693

(22) Filed: Dec. 3, 2013

(51) Int. Cl. B29C 43/00; B32B 27/28; B32B 3/02; B32B 27/08

(52) U.S. Cl. CPC B29C 43/006; B32B 27/08; B32B 27/286; B32B 27/285; B32B 3/02; B32B 27/288; B32B 27/281; B32B 2262/101; B32B 2262/106; B32B 2262/103; B32B 2262/105; B32B 2305/076; B32B 2605/18; B29K 2101/12

(57) ABSTRACT

A hybrid composite structure includes a molded thermoplastic composite component and a laminate thermoplastic composite component co-welded together. The molded component is reinforced with discontinuous fibers, and the laminate component is reinforced with continuous fibers.

### CROSS REFERENCE TO RELATED APPLICATIONS

This application is related to co-pending U.S. patent application Ser. No. ______, (Attorney Docket No. 12-1660-US-NP) filed concurrently herewith on ______, and co-pending U.S. patent application Ser. No. ______, (Attorney Docket No. 13-0763-US-NP) filed concurrently herewith on ______, both of which applications are incorporated by reference herein in their entireties.

### BACKGROUND INFORMATION

1. Field

The present disclosure generally relates to the fabrication of fiber reinforced thermoplastic structures, and deals more particularly with hybrid laminate and molded thermoplastic structures.

2. Background

In the aircraft and other industries, composite structures such as beams and stiffeners are fabricated using thermoset prepreg tape layup techniques, and autoclave curing. Bandwidths of prepreg tape or tows are laid up side-by-side to form a multi-ply laminate that is vacuum bagged and autoclave cured. In some applications where the structure requires connection at load input locations, custom metal fittings are separately machined and then fastened to the laminate structure. Laminate structures such as beams are formed by assembling two or more composite laminate components. Due to the geometry of the components, gaps or cavities may be present in joints between the components. In order to strengthen these joints, fillers, sometimes referred to as “noodles”, must be installed in the joints.

The composite laminate fabrication process described above is time-consuming, labor intensive and requires expensive capital equipment such as automatic fiber placement machines. In some cases, these composite laminate structures may be heavier than desired because of the need for ply reinforcements in certain areas of the parts. Moreover, the need for fillers increases fabrication costs and may not provide sufficient strengthening of joints for some applications.

Accordingly, there is a need for a method of producing composite structures that reduces the need for prepreg tape layup, and which eliminates joints in the structure that require fillers. There is also a need for composite structures that can be produced more easily and economically, while maintaining the required strength and allowing integration of fittings or other special features.

### SUMMARY

The disclosed embodiments provide a method of producing a hybrid composite structure quickly and easily, and which reduces the need for laying up individual lamina. The hybrid composite structure includes first and second thermoplastic components that are co-welded. The first thermoplastic component is reinforced with randomly oriented, discontinuous fibers and may be produced by compression molding. Compression molding of the first component allows integration of one or more integral fittings and forming of complex or special structural features. The use of compression molding also eliminates joints in the structure that may require fillers. The second thermoplastic component is a laminate that is reinforced with continuous fibers in order to provide the structure with the overall strength and rigidity required for the application

According to one disclosed embodiment, a method is provided of making a composite structure. A thermoplastic resin first component is molded which is reinforced with discontinuous fibers. A thermoplastic resin second component is laid up which is reinforced with substantially continuous fibers. The first and second components are co-welded.

According to another disclosed embodiment, a method is provided of making a composite structure. A fiber reinforced, thermoplastic component is molded which has a web and at least one flange integral with the web. A fiber reinforced, thermoplastic cap is laid up and placed on the flange. The thermoplastic cap is joined with the flange.

According to a further embodiment, a method is provided of making a composite beam. The beam is molded using thermoplastic prepreg flakes, and at least one cap is produced using thermoplastic prepreg tape. The cap and the beam are co-welded.

According to still another embodiment, a hybrid composite structure comprises first and second thermoplastic resin components. The first thermoplastic resin component is reinforced with discontinuous fibers, and the second thermoplastic resin component is reinforced with continuous fibers and joined to the first thermoplastic resin component.

According to another embodiment, a composite structure comprises a composite beam formed of a thermoplastic resin reinforced with randomly oriented, discontinuous fibers. The beam includes a web and a pair of flanges integral with the web. The composite structure further includes at least one composite cap joined to one of the flanges. The composite is formed of a thermoplastic resin reinforced with continuous fibers.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and advantages thereof, will best be understood by reference to the following detailed description of an illustrative embodiment of the present disclosure when read in conjunction with the accompanying drawings, wherein:

FIG. 1 is an illustration of a perspective view of a hybrid composite structure having integrated fittings produced according to the disclosed method.

FIG. 2 is an illustration of an exploded, perspective view of the hybrid structure of FIG. 1.

FIG. 3 is an illustration of a sectional view taken along the line 3-3 in FIG. 1.

FIG. 4 is an illustration of the area designated as FIG. 4 in FIG. 3.

FIG. 5 is an illustration of a plan view of a thermoplastic prepreg flake.

FIG. 6 is an illustration of a perspective view of an automatic fiber placement machine laying up a cap on a molded composite flange.

FIG. 7 is an illustration of a diagrammatic side view of a continuous compression molding machine.

FIG. 8 is an illustration of a perspective view of a contoured, hybrid composite hat stringer produced according to the disclosed method.

FIG. 9 is an illustration of a perspective view of a contoured, hybrid composite frame member produced according to the disclosed method.

FIG. 10 is an illustration of a flow diagram of a method of producing hybrid composite structures.

FIG. 11 is an illustration of a flow diagram illustrating additional details of the disclosed method.

FIG. 12 is an illustration of a flow diagram of aircraft production and service methodology.

FIG. 13 is an illustration of a block diagram of an aircraft.

### DETAILED DESCRIPTION

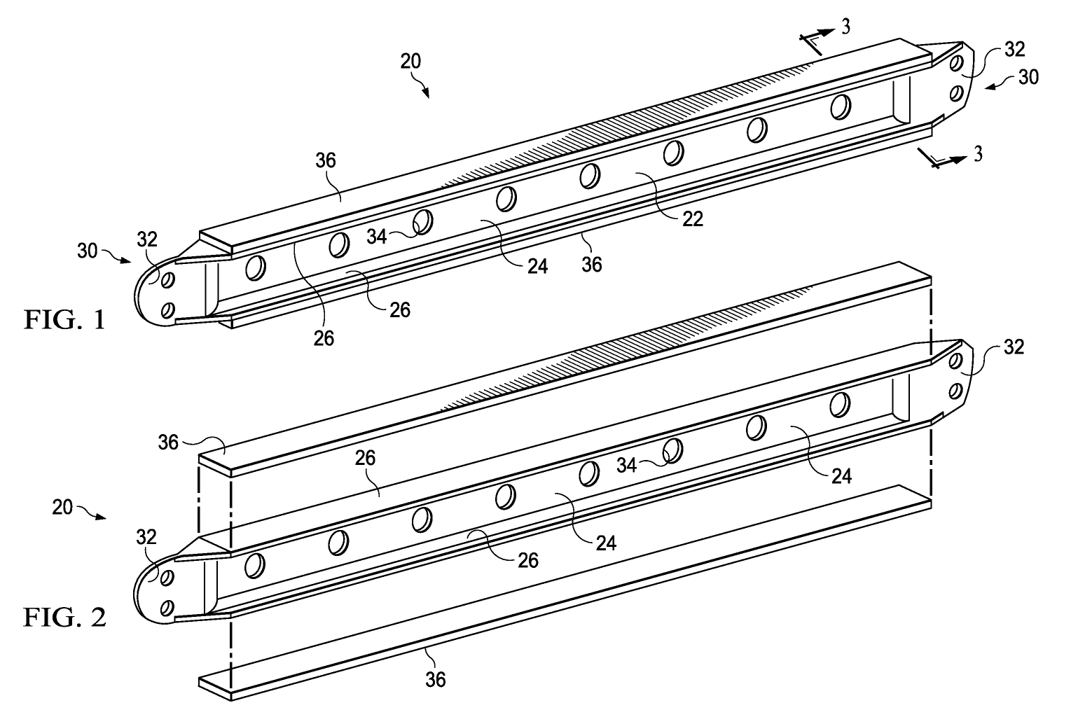

Referring first to FIGS. 1 and 2, a hybrid composite structure 20 broadly comprises a molded first composite component 22 and a laminated second component 36 for strengthening and stiffening the first component 22. In the exemplar, the first component 22 comprises a unitary beam 22 formed of a molded, thermoplastic composite (“TPC”) material, however as will be discussed later, the first component 22 may have any of various shapes and configurations suitable for transferring loads for a particular application, including shapes that have one or more curves or contours along their length. The second component 36 comprises a TPC cap 36 joined with the beam 22.

The beam 22 includes a pair of flanges 26 connected by a central web 24, forming an I-shaped cross-section. Web 24 may include one or more lightening holes 34 to reduce the weight of the beam 22. The beam 22 also includes a pair of fittings 30 on opposite ends thereof. In the illustrated example, the fittings 30 comprise TPC lugs 32 that are formed integral with the web 24 and the flanges 26. The illustrative lugs 32 are, however merely illustrative of a wide variety of fittings and features that may be formed integral with the beam 22 using molding techniques described below. Moreover, the fittings 30 may comprise metal fittings that are co-molded with the TPC web 24 and TPC flanges 26. The TPC cap 36 is a laminate that covers and is co-welded to each of the flanges 26. The TPC laminate caps 36 function to stiffen and strengthen the molded TPC beam 22.

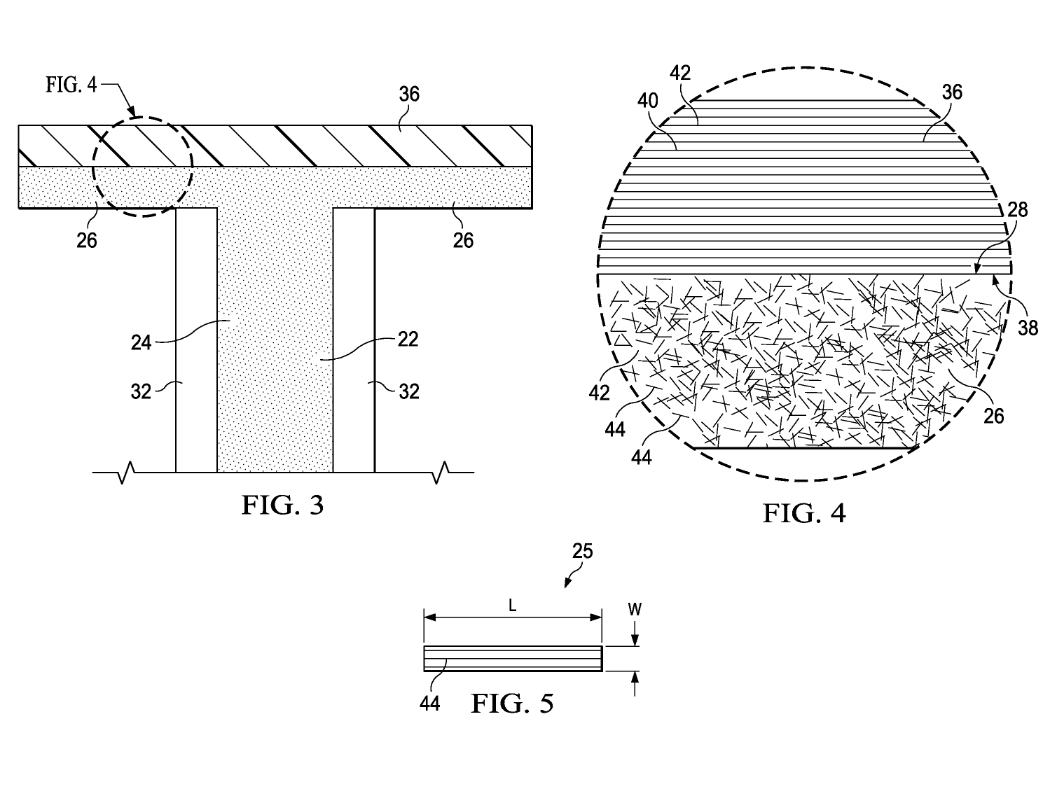

Referring now also to FIG. 3, each of the flanges 26 of the unitary beam 22 is formed integral with both the web 24 and the lugs 32. The flanges 26 and the web 24 form a continuous T-shaped cross-section that is devoid of cavities or gaps that may require a filler. As shown in FIG. 4, the beam 22 is formed of a molded thermoplastic resin 42 that is reinforced with dispersed, randomly oriented, discontinuous fibers 44. Each of the TPC laminate caps 36 is formed by multiple lamina comprising thermoplastic resin 42 that is reinforced with continuous fibers 40 having any desired orientation or combination of orientations according to a predetermined ply schedule (not shown). The first and second components 22, 36 (beam 22 and caps 36) are co-welded along corresponding faying surfaces 28, 38. Co-welding may be achieved using any of several techniques that will be discussed below in more detail.

Referring to FIGS. 4 and 5, the beam 22 may be produced by any suitable molding technique, such as compression molding, in which a charge (not shown) of thermoplastic prepreg fiber flakes 25 is introduced into a mold cavity (not shown) having the shape of the beam 22. The charge is heated to the melt temperature of the thermoplastic resin until the resin in the flakes 25 melts and becomes flowable, forming a flowable mixture of a thermoplastic resin and discontinuous, randomly oriented fibers. The flowable mixture is compressed to fill the mold cavity and then quickly cooled and removed from the mold. As used herein, “flakes” “TPC flakes” and “fiber flakes” refer to individual pieces, fragments, slices, layers or masses of thermoplastic resin that contain fibers suitable for reinforcing the beam 22.

In the embodiment illustrated in FIG. 5, each of the fiber flakes 25 has a generally rectangular, long thin shape in which the reinforcing fibers 44 have the substantially same length L and a width W. In other embodiments however, the fiber flakes 25 may have other shapes, and the reinforcing fibers 44 may vary in length L. The presence of fibers 44 having differing lengths may aid in achieving a more uniform distribution of the fiber flakes 25 in the beam 22, while promoting isotropic mechanical properties and/or strengthening the beam 22. In some embodiments, the mold charge may comprise a mixture of TPC flakes 25 having differing sizes and/or shapes. The fiber flakes 25 may be “fresh” flakes produced by chopping bulk prepreg tape to the desired size and shape. Alternatively, the fiber flakes 25 may be “recycled” flakes that are produced by chopping scrap prepreg TPC material to the desired size and shape.

The thermoplastic resin which forms part of the flakes 25 may comprise a relatively high viscosity thermoplastic resin such as, without limitation, PEI (polyetherimide) PPS (polyphenylene sulphide), PES (polyethersulfone), PEEK (polyetheretherketone), PEKK (polyetheretherketone), and PEKK-FC (polyetherketoneketone-fc grade), to name only a few. The reinforcing fibers 44 in the flakes 25 may be any of a variety of high strength fibers, such as, without limitation, carbon, metal, ceramic and/or glass fibers.

The TPC laminate caps 36 may be produced using any of a variety of techniques. For example, the cap 36 may be laid up by hand by stacking plies of fiber prepreg having desired fiber orientations according to a predetermined ply schedule. In one embodiment, the ply stack may be consolidated, trimmed to the desired dimensions and then placed on the flanges 26, following which the caps 36 may be co-welded with the flanges 26. The placement of the consolidated ply stack on the flange 26 may be performed by hand, or using a pick-and-place machine (not shown). In another embodiment, a ply stack may be formed directly on the flange 26 and then consolidated by placing the structure 20 in a mold, compressing the flanges 26 and the caps 36 together and heating the ply stack to the melt temperature of the resin. The necessary heating may be achieved using a self-heated mold, or by placing the mold within an oven. The simultaneous heating of both the ply stack and flanges 26 results in melting of the resin at the faying surfaces 28, 38 (FIG. 4) thereby co-welding the caps 36 and flanges 26. It should be noted here that any of a variety of other techniques may be used to melt the thermoplastic resin at the faying surfaces 28, 38, thereby co-welding the caps 36 and the flanges 26, including but not limited to laser welding, ultrasonic welding, induction welding and resistance welding, to name only a few.

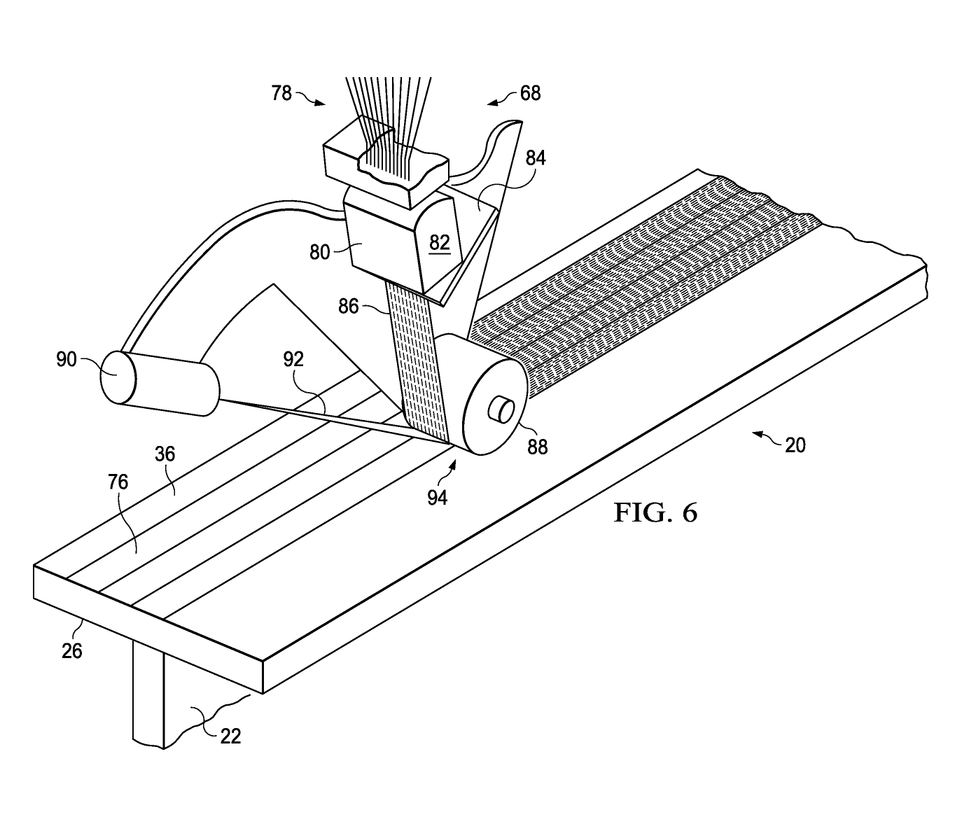

It may be also possible to layup the cap 36 in situ using automatic fiber placement (AFP) equipment to form the lamina (composite plies) of the cap 36, either on a layup tool (not shown) or directly on the flanges 26. A typical AFP machine 68 suitable for laying up the caps 36 is shown in FIG. 6. In the illustrated example, the AFP machine 68 is used as an end effecter on a manipulator (not shown) to layup the lamina of the cap 36 directly on the flanges 26.

The AFP machine 68 is computer numerically controlled and includes combs 80 that guide incoming prepreg tows 78 (or tape strips) into a ribbonizer 82 which arranges the tows 78 side-by-side into a bandwidth 86 of prepreg fiber material. A tow cutter 84 cuts the bandwidth 86 to a desired length. The bandwidth 86 passes beneath a compliant roller 88 that applies and compacts the bandwidth 86 onto the flange 26, or onto an underlying ply that has already been placed on the flange 26. The bandwidths 86 are laid down in parallel courses of thermoplastic prepreg tape or prepreg tows 78 to form the individual plies or lamina of the cap 36. The courses 76 are laid down with fiber orientations at preselected angles relative to a reference direction, according to a predetermined ply schedule. In the illustrated example, the courses 76 of the ply being formed have fiber orientations of 0 degrees. Optionally, a laser 90 or similar heat source such as a hot gas torch, an ultrasonic torch or an infrared source, may be mounted on the AFP machine 68 for heating and melting the faying surfaces 28, 38 (FIG. 4) of the flange 26 and the cap 36. The laser 90 projects a beam 92 which impinges on both the flange 26 and the bandwidth 86 of the tows 78 in the area 94 where the bandwidth 86 is being laid down on the flange 72. The beam 92 melts the resin in both the tows 78 and a layer of the underlying of the flange 26, thereby co-welding the cap 36 and the flange 26 “on-the-fly”.

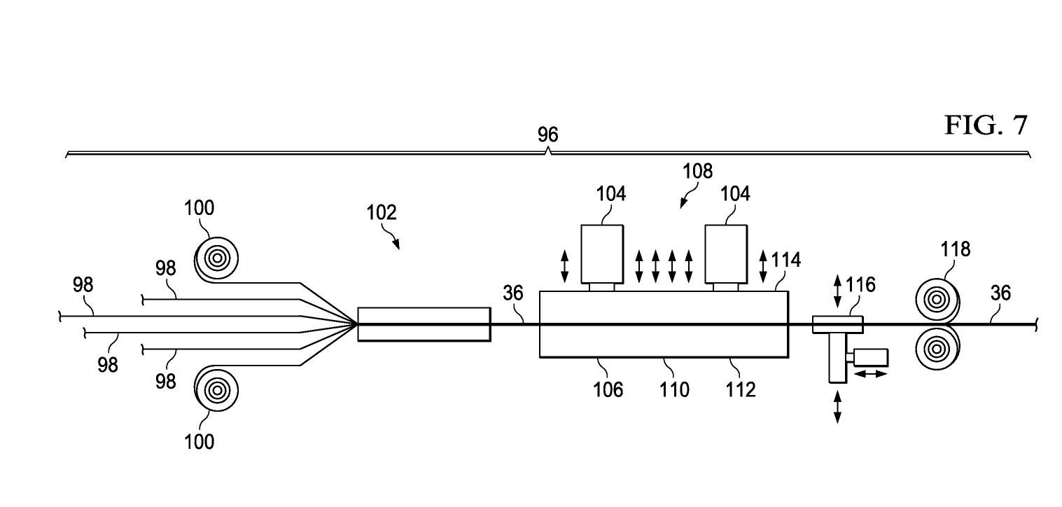

In another embodiment, the TPC laminate caps 70 containing continuous fiber reinforcement may be produced using a continuous compression molding (CCM) machine shown in FIG. 7. The CCM machine 96 broadly comprises a pre-forming zone 102 and a consolidation zone 108. In the pre-forming zone 102, plies 98 of fiber reinforced thermoplastic material are loaded in their proper orientations into a ply stack, and combined with tooling 100.

The stack of plies 98 are fed, along with the tooling 100, into the pre-forming zone 102 where they are preformed to the general shape of the cap 36 at an elevated temperature. The pre-formed cap 36 then exits the pre-forming zone 102 and enters the consolidation zone 108, where it is consolidated to form a single, integrated TPC laminate cap 36. The elevated temperature used to pre-forming the cap 36 is sufficiently high to cause softening of the plies 98 so that the plies 98 may be bent, if desired, during the pre-forming process.

The preformed cap 36 enters a separate or connected consolidating structure 104 within the consolidation zone 108. The consolidating structure 104 includes a plurality of standardized tooling dies generally indicated at 114 that are individually mated with the tooling 100. The consolidating structure 104 has a pulsating structure 116 that incrementally moves the preformed cap 36 forward within the consolidation zone 108 and away from the pre-forming zone 102. As the cap 36 moves forward, the cap 36 first enters a heating zone 106 that heats the cap 36 to a temperature which allows the free flow of the polymeric component of the matrix resin of the plies 98.

Next, the cap 36 moves forward to a pressing zone 110, wherein standardized dies 114 are brought down collectively or individually at a predefined force (pressure) sufficient to consolidate (i.e. allow free flow of the matrix resin) the plies 98 into its desired shape and thickness. Each die 114 may be formed having a plurality of different temperature zones with insulators. The dies 114 are opened, and the cap 36 is advanced within the consolidating structure 104 away from the pre-forming zone 102. The dies 114 are then closed again, allowing a portion of the preformed cap 36 to be compressed under force within a different temperature zone. The process is repeated for each temperature zone of the die 114 as the preformed cap 36 is incrementally advanced toward a cooling zone 112.

In the cooling zone 112, the temperature of the formed and shaped cap 36 may be brought below the free flowing temperature of the matrix resin of the plies 98, thereby causing the fused or consolidated cap 36 to harden to its ultimate pressed shape. The fully formed and consolidated cap 36 then exits the consolidating structure 104, where the tooling members 100 may be collected at 118.

The CCM machine 96 described above may be particularly suitable for producing caps 36 or similar components have one or more curves or contours along their lengths, however other techniques may be used to produce TPC laminate caps 36 with continuous fiber reinforcement, including but not limited to pultrusion or roll forming.

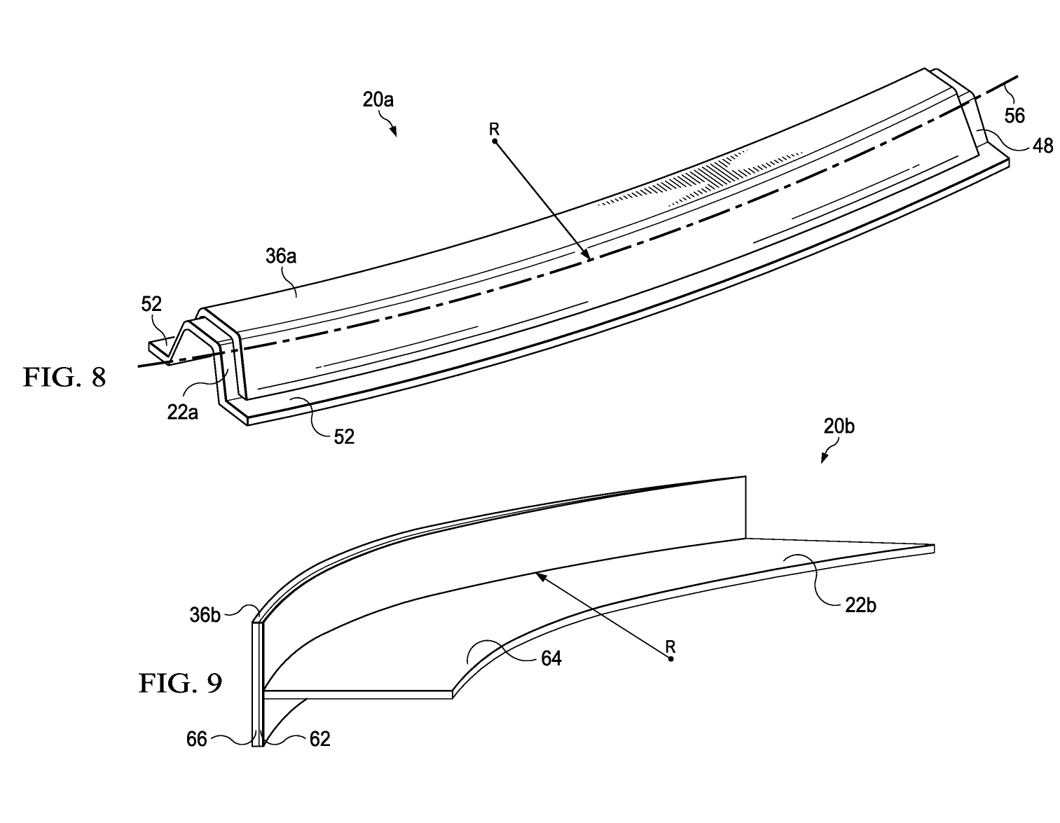

As previously mentioned the hybrid composite structure 20 produced according to the disclosed method may include one or more curvatures or contours. For example, referring to FIG. 8, the composite structure 20 may be a hat stringer 20a. The hat stringer 20a comprises a first component 22a formed of a thermoplastic resin reinforced with discontinuous, randomly oriented fibers, and a second component 36a formed of a thermoplastic resin reinforced with continuous fibers. The first component 22a includes a hat shaped section 48 and outwardly extending flanges 52. The second component 36a is hat shaped in cross-section. The hat shaped second component 36a covers and is co-welded with the hat shaped section 48. Both the first and second components, 22a, 36a have a common longitudinal axis 56 that is curved along a radius R.

FIG. 9 illustrates still another example of a hybrid composite structure 20b produced in accordance with the disclosed method. In this example, the composite structure 20b comprises a first molded TPC component 22b and a second TPC laminate component 36b which are each curved along a radius R. The first component 22b, which has a T-shaped cross-section, is formed from a thermoplastic resin reinforced with randomly oriented, discontinuous fibers, and comprises a flange 62 integrally formed with a central web 64. The second component 36b of the composite structure 20b is a laminate formed from a thermoplastic resin reinforced with continuous fibers of desired orientations, and comprises a cap 66 co-welded with the flange 62.

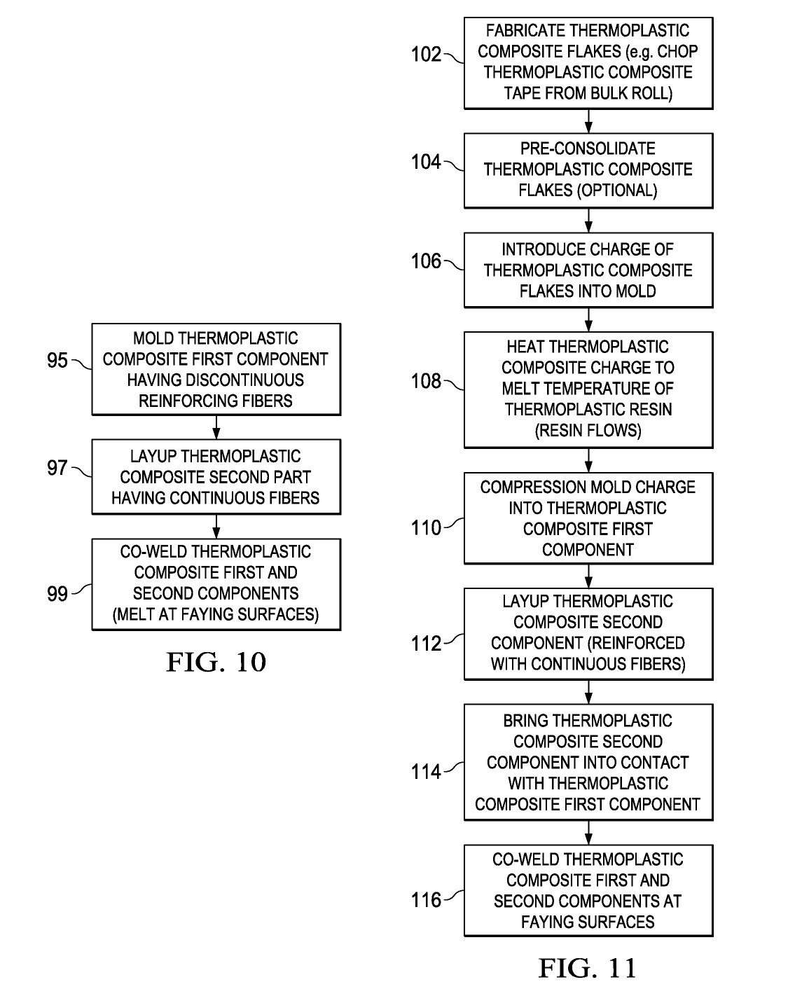

FIG. 10 broadly illustrates the overall steps of a method of producing a hybrid composite structure 20 of the type previously described. At step 95, a TPC first component 22 is molded which has discontinuous reinforcing fibers. At step 97, a TPC second component 36 is laid up which has continuous reinforcing fibers. At step 99, the TPC first and second components 22, 36 are co-welded by melting the two components 22, 36 along their respective faying surfaces 28, 38.

FIG. 11 broadly illustrates the overall steps of a method of producing a hybrid composite structure 20, such as the composite beam shown in FIGS. 1 and 2. Beginning at 102, thermoplastic fiber prepreg flakes 25 are fabricated, and as by chopping TPC tape from a bulk roll. At 104, optionally, the TPC fiber flakes 25 may be preconsolidated by heating and compressing them. At 106, a charge of the TPC fiber flakes 25 is introduced into a mold. At 108, the TPC fiber charge is heated to the melt temperature of the thermoplastic resin in the flakes 25, resulting in the resin becoming flowable and filling the mold. At 110, the mold charge is compressed and molded into the TPC first component 22. At 112, the TPC second component 36, which is reinforced with continuous fibers, is laid up using any of the techniques discussed previously. At 114, the TPC first and second components 22, 36 are brought into contact along their respective faying surfaces 38, 28. At 116, the TPC first and second components 22, 36 are co-welded along their respective faying surfaces 38, 28.

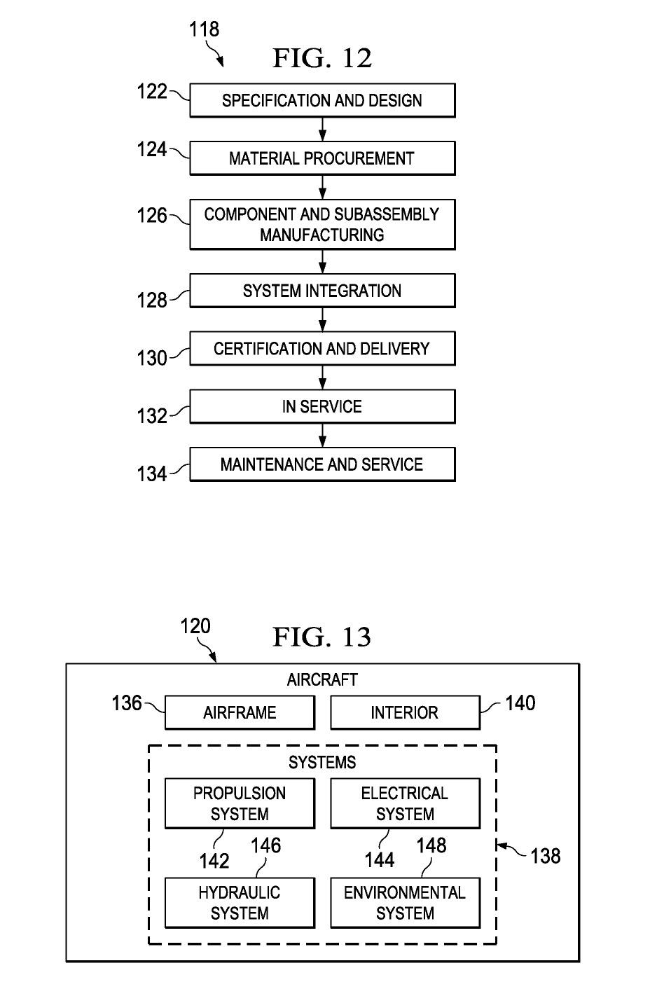

Embodiments of the disclosure may find use in a variety of potential applications, particularly in the transportation industry, including for example, aerospace, marine, automotive applications and other application where composite structural members, such as beams, stringers and stiffeners, may be used. Thus, referring now to FIGS. 12 and 13, embodiments of the disclosure may be used in the context of an aircraft manufacturing and service method 118 as shown in FIG. 12 and an aircraft 120 as shown in FIG. 13. Aircraft applications of the disclosed embodiments may include, for example, without limitation, floor beams, spars, ribs, frame sections, stiffeners and other composite structural members. During pre-production, exemplary method 118 may include specification and design 122 of the aircraft 120 and material procurement 124. During production, component and subassembly manufacturing 126 and system integration 128 of the aircraft 120 takes place. Thereafter, the aircraft 120 may go through certification and delivery 130 in order to be placed in service 132. While in service by a customer, the aircraft 120 is scheduled for routine maintenance and service 134, which may also include modification, reconfiguration, refurbishment, and so on.

Each of the processes of method 118 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 13, the aircraft 120 produced by exemplary method 118 may include an airframe 136 with a plurality of systems 138 and an interior 140. Examples of high-level systems 138 include one or more of a propulsion system 142, an electrical system 144, a hydraulic system 146 and an environmental system 148. Any number of other systems may be included. Although an aerospace example is shown, the principles of the disclosure may be applied to other industries, such as the marine and automotive industries.

Systems and methods embodied herein may be employed during any one or more of the stages of the production and service method 118. For example, components or subassemblies corresponding to production process 126 may be fabricated or manufactured in a manner similar to components or subassemblies produced while the aircraft 120 is in service. Also, one or more apparatus embodiments, method embodiments, or a combination thereof may be utilized during the production stages 126 and 128, for example, by substantially expediting assembly of or reducing the cost of an aircraft 120. Similarly, one or more of apparatus embodiments, method embodiments, or a combination thereof may be utilized while the aircraft 120 is in service, for example and without limitation, to maintenance and service 134.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of making a composite structure, comprising:
molding a thermoplastic resin first component reinforced with discontinuous fibers;
laying up a thermoplastic resin second component reinforced with substantially continuous fibers; and
co-welding the thermoplastic resin first and second components.

2. The method of claim 1, wherein molding the thermoplastic resin first component is performed by compression molding a flowable mixture of a thermoplastic resin and discontinuous, randomly oriented fibers.

3. The method of claim 2, wherein the compression molding includes:
placing a charge of thermoplastic prepreg flakes in a mold,
forming a flowable mixture of a resin and fibers by melting the thermoplastic resin in the prepreg flakes, and
compressing the flowable mixture within the mold.

4. The method of claim 3, wherein:
the compression molding includes cooling the thermoplastic resin first component after it has been molded, and
co-welding the thermoplastic resin first and second components includes heating the thermoplastic resin first and second components to a melt temperature of thermoplastic resin in the thermoplastic resin first and second component.

5. The method of claim 1, wherein the co-welding is performed by:
assembling the thermoplastic resin first and second components together along faying surfaces of the thermoplastic resin first and second components, and
melting the faying surfaces.

6. The method of claim 5, wherein melting the faying surfaces is performed by placing the assembled thermoplastic resin first and second components in an oven.

7. The method of claim 1, further comprising:
consolidating the thermoplastic resin second component before the co-welding is performed.

8. The method of claim 1, wherein:
laying up the thermoplastic resin second component is performed by laying up plies on a surface of the thermoplastic resin first component, and
the co-welding is performed as the thermoplastic resin second component is being laid up on the surface of the thermoplastic resin first component.

9. The method of claim 8, wherein the co-welding is performed by locally melting faying surfaces of the thermoplastic resin first and second components as the thermoplastic resin second component is being laid up on the surface of the thermoplastic resin first component.

10. A composite structure made by the method of claim 1.

11. A method of making a composite structure, comprising:
compression molding a fiber reinforced, thermoplastic component having a web and at least one flange integral with the web;
laying up a fiber reinforced, thermoplastic cap;
placing the thermoplastic cap on the flange; and
joining the thermoplastic cap with the flange.

12. The method of claim 11, wherein the compression molding includes:
introducing a charge of thermoplastic prepreg flakes into a mold having a mold cavity corresponding to the shape of the web and the flange,
heating the mold until resin in the thermoplastic prepreg flakes melts and becomes flowable, and
compressing the flowable resin within the mold.

13. The method of claim 11, wherein laying up the fiber reinforced, thermoplastic cap is performed by laying up courses of thermoplastic prepreg tape on the flange.

14. The method of claim 13, wherein joining the thermoplastic cap with the flange is performed by locally melting faying surfaces of the prepreg tape and the flange as the courses are being laid up.

15. The method of claim 11, wherein laying up the fiber reinforced, thermoplastic cap is performed using an automatic fiber placement machine to layup a plurality of composite plies.

16. The method of claim 11, wherein joining the thermoplastic cap with the flange is performed by co-welding the thermoplastic cap and the flange.

17. A method of making a composite beam, comprising:
molding a beam using thermoplastic prepreg flakes;
producing at least one cap using thermoplastic prepreg tape; and
co-welding the cap and the beam.

18. A hybrid composite structure, comprising:
a first thermoplastic resin component reinforced with discontinuous fibers; and
a second thermoplastic resin component reinforced with continuous fibers and joined to the first thermoplastic resin component.

19. The hybrid composite structure of claim 18, wherein the first thermoplastic resin component includes a web and at least one flange integral with the web.

20. The hybrid composite structure of claim 19, wherein the second thermoplastic resin component includes a cap co-welded with the flange.

21. The hybrid composite structure of claim 19, wherein the first thermoplastic resin component includes at least one fitting formed integral with at least one of the web and the flange.

22. The hybrid composite structure of claim 18, wherein the second thermoplastic resin component includes a plurality of laminated plies of thermoplastic resin reinforced with continuous fibers.

23. A composite structure, comprising:
a composite beam formed of a thermoplastic resin reinforced with randomly oriented, discontinuous fibers, the beam including a web and a pair of flanges integral with the web; and
at least one composite cap joined to one of the flanges, the composite cap formed of a thermoplastic resin reinforced with continuous fibers.

24. The composite structure of claim 23, wherein each of the composite beam and the composite cap have at least one contour along its length.

25. The composite structure of claim 23, wherein:
the at least one composite cap and the at least one flange each have faying surfaces, and
the at least one composite cap and the at least one flange are co-welded along the faying surfaces.
